(19) United States
(12) Patent Application Publication
(10) Pub. No.: US 2005/0261923 A1
(43) Pub. Date: Nov. 24, 2005

(54) Method and apparatus for model based subscriptions for a publish/subscribe messaging system

(75) Inventors: Kyle Gene Brown, Apex, NC (US); Keyur D. Dalal, Cary, NC (US); Mark Douglas Weitzel, Durham, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/850,716

(22) Filed: May 21, 2004

(51) Int. Cl. G06F 17/60

(52) U.S. Cl. 705/1

(57) ABSTRACT

A method, system, and computer instructions for using the language of the business domain to express subscriptions to a publish/subscribe messaging system. The resulting notifications sent to the subscriber are instances of the business model used to create the subscription. In other words, a subscriber may subscribe to the messaging system against the same information that the subscriber receives in a notification from the messaging system. The present invention uses the model from the business domain as the basis for notification subscriptions to allow for defining filters directly against the model's attributes, reducing problems caused by translating business models to a middleware description.

### BACKGROUND OF THE INVENTION

1. Technical Field

The present invention relates generally to an improved data processing system. In particular, the present invention relates to a method, apparatus, and computer instructions for using business models directly in message oriented middleware.

2. Description of Related Art

Component-based distributed enterprise computing is an appealing solution to business computing needs. Rather than requiring extensive custom software (and in some cases hardware) to be written to meet the particular enterprise, a component-based distributed enterprise computing model allows different individual applications, services, or other components, possibly operating in disparate hardware or software environments, to interoperate. Distributed enterprise computing systems achieve this interoperability through the use of middleware.

Middleware is software that provides a platform for interoperation between software components in a distributed system. Message-oriented middleware is often used in application integration strategies. One common interaction pattern supported by this type of middleware is publish/subscribe. FIG. 1 is a block diagram of a conventional publish/subscribe system. Typical publish/subscribe system 100 comprises publishers, such as notification provider 102, which generate messages, and subscribers, such as subscriber 104, which receive these messages. Messages generated by notification provider 102 are sent to message broker 106, which in turn sends these messages to subscriber 104 that has previously subscribed to receive some or all of these notifications.

Currently, publish/subscribe systems employ a topic-based approach to publishing messages. Subscriber 104 first registers to receive messages based on a subject or topic name. Subscriber 104 may register using explicit subject or topic names or, alternatively, use wildcards to receive a broader subscription. Publisher 102 sends the message to subscriber 104 only if the subscription matches the published topic.

Business analysts in an industry may define an organization in terms of the organization's processes, rules, and goals of the organization, as well as elements within the organizational structure and the relationship between these elements. The analysts then create business models for the application domain using a rich hierarchy of objects. An object may represent a single component or element of a business process and the interactions between objects can be shown through workflow diagrams. However, there is a juxtaposition between the business model that is used to represent the application domain and how conventional messaging systems, such as publish/subscribe, create topics for subscription.

Consider the example of a developer who is responsible for one component, called ‘AutoTeller’, which is part of a large enterprise application, e-Bank. For the sake of example, assume that the application used to system test the developer's code is capable of producing notifications by publishing test records that detail the causes of failure.

In the scenario above, the developer would like to be notified when his component causes a test case to fail on Linux and Windows because of a null pointer exception. Using Java Message Service (JMS), the developer may create notification topics such as the topics below:
e-Bank/AutoTeller/test/linux/failure/nullpointer/
e-Bank/AutoTeller/test/windows/failure/nullpointer/
   Unfortunately, using topics in this manner can potentially lead to a large number of notification topics (topic explosion).

In an alternative example, conventional publish/subscribe systems may employ a combination of notification topics and message selectors to match fields in the header. For example, the topic may be “e-Bank/AutoTeller” with a selector/header of:
ProcessNode=′Test′
Platform=′Linux′
Condition=′Failure′
Reason=′NullPointer′
   It may be necessary for the message to contain the same information that is repeated in the header. Furthermore, it may be difficult to express all attributes in message headers, e.g., when the model contains multiple levels (a test record contains an extended data field).

Therefore, it would be advantageous to have a method, apparatus, and computer instructions for allowing business models to be used directly in message oriented middleware, and specifically in publish/subscribe brokers.

### SUMMARY OF THE INVENTION

The present invention provides a method, system, and computer instructions for using the language of the business domain to express subscriptions to a publish/subscribe messaging system. The resulting notifications sent to the subscriber are instances of the business model used to create the subscription. A subscriber may subscribe to the messaging system against the same information that the subscriber receives in a notification from the messaging system. The present invention uses the model from the business domain as the basis for notification subscriptions to allow for defining filters directly against the model's attributes, reducing problems caused by translating business models to a middleware description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a known publish/subscribe messaging system;

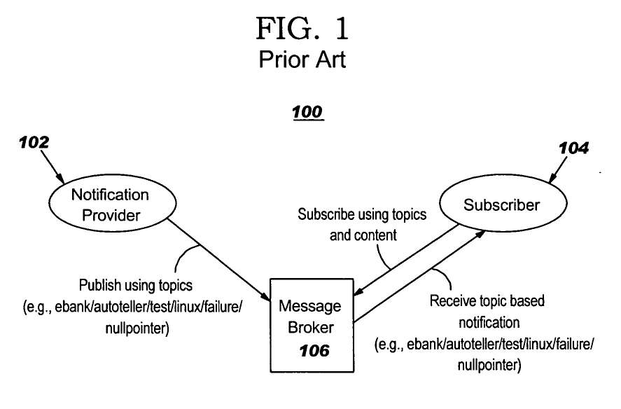

FIG. 2 is a diagram of a network of distributed data processing systems in which the present invention may be implemented;

FIG. 3 is a block diagram of a data processing system in which the present invention may be implemented;

FIG. 4 is a block diagram of a Firefly Runtime notification framework for implementing a preferred embodiment of the present invention;

FIG. 5 is a class diagram illustrating an example notification framework subscription model in accordance with a preferred embodiment of the present invention;

FIG. 6A is a class diagram of an example notification model;

FIG. 6B is an example graphical user interface illustrating a sample set of subscriptions to the model described in FIG. 6A;

FIG. 7 is an example graphical user interface illustrating how business models may be registered with a notification broker in accordance with a preferred embodiment of the present invention;

FIGS. 8A and 8B are example graphical user interfaces illustrating how a user may subscribe against a provider's notification models in accordance with a preferred embodiment of the present invention;

FIG. 9 is an example graphical user interface illustrating how filters may be added against attributes in accordance with a preferred embodiment of the present invention;

FIG. 10 is an example graphical user interface illustrating a subscriptions tree view in accordance with a preferred embodiment of the present invention;

FIG. 11 is an example graphical user interface illustrating how delivery channels may be selected to dispatch notifications in accordance with a preferred embodiment of the present invention;

FIG. 12 is an example graphical user interface illustrating notifications delivered via Web services in accordance with a preferred embodiment of the present invention;

FIG. 13 is an example graphical user interface display illustrating how notifications may be received by a subscriber in accordance with a preferred embodiment of the present invention; and

FIG. 14 is a flowchart of a process for using business models for subscriptions in accordance with a preferred embodiment of the present invention.

### DETAILED DESCRIPTION OF THE PREFERRED EMBODIMENT

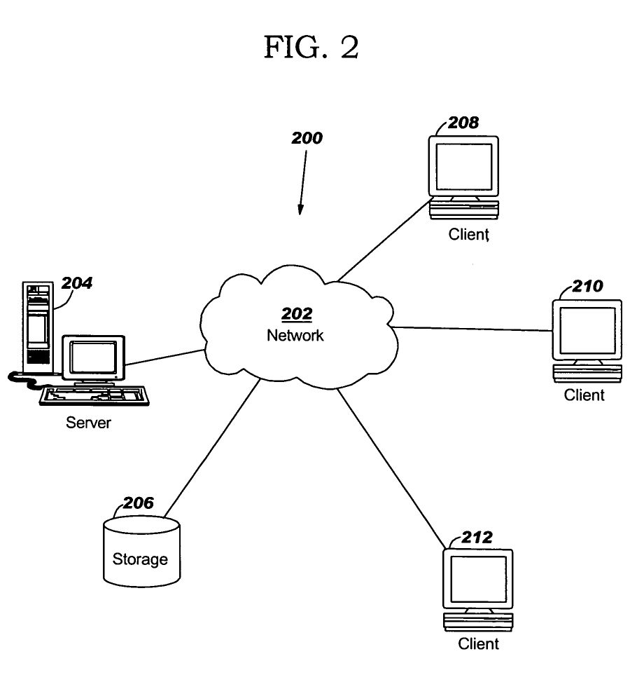

With reference now to the figures and in particular with reference to FIG. 2, a block diagram of a distributed data processing system is depicted in which the present invention may be implemented. Distributed data processing system 200 is a network of computers in which the present invention may be implemented. Distributed data processing system 200 contains a network 202, which is the medium used to provide communications links between various devices and computers connected together within distributed data processing system 200. Network 202 may include permanent connections, such as wire or fiber optic cables, or temporary connections made through telephone connections. Distributed data processing system 200 may be for example, the Internet, a local area network, or a wide area network.

In the depicted example, a server 204 is connected to network 202 along with storage unit 206. In addition, client 208, 210, and 212 also are connected to network 202. These clients may be, for example, without limitation, personal computers or network computers. A network computer is any computer, coupled to a network, which receives a boot image from another computer coupled to the network and also may be a server managed computer. Server 204 provides data, and may be form example, a web server on the Internet, and applications to clients 208-212. Clients 208, 210, and 212 are clients to server 204. Distributed data processing system 200 may include additional servers, clients, and other devices not shown. FIG. 2 is intended as an example, and not as an architectural limitation for the processes of the present invention.

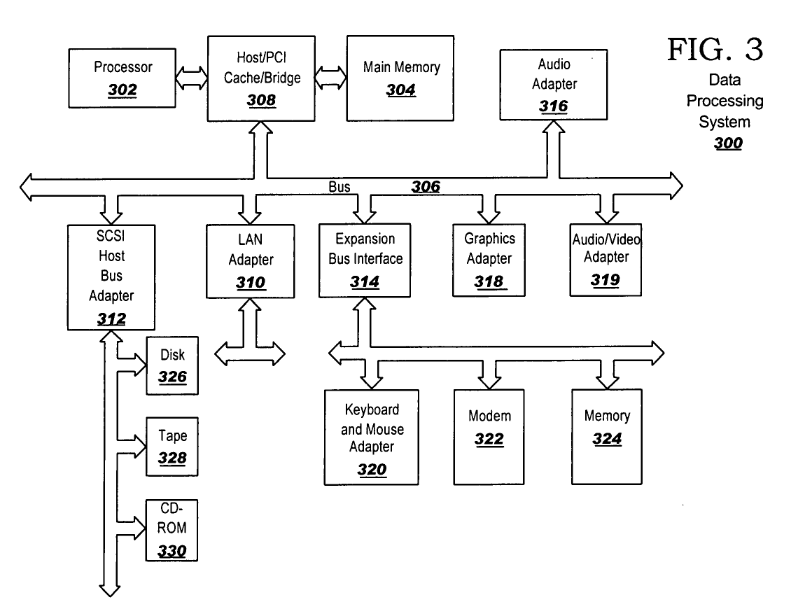

Turning next to FIG. 3, a block diagram of a data processing system 300 in which the present invention may be implemented is illustrated. Data processing system 300 may be used either as a server or a computer. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM 330 in the depicted example. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. The depicted example is not meant to imply architectural limitations with respect to the present invention.

The present invention provides a method, system, and computer instructions for using business models directly in message oriented middleware. In particular, the present invention allows for using the language of the business domain to express subscriptions to a publish/subscribe messaging system. By using business models when subscribing to a publish/subscribe system, the resulting notifications sent to the subscriber are actually instances of the business model used to create the subscription. In other words, a subscriber may subscribe to the messaging system against the same information that the subscriber receives in a notification from the messaging system. The present invention provides a mechanism to introspect on a business model and define filters directly against the business model's attributes. By using business models defined by business analysts directly in the message-oriented middleware, no translation of the business model to middleware description is necessary.

An application framework, such as Firefly Runtime framework which is a product of International Business Machines Corporation located in Armonk, N.Y., may be used to easily create an environment that facilitates the construction of integrated, server-based, application development components. Firefly Runtime is a framework that enables enterprise integration using a messaging based infrastructure. Firefly Runtime allows for loose coupling between applications and for notifications from applications to be routed to other applications as well as users of those applications.

To implement the present invention, a notification provider, which is a system that generates notifications and sends them to a notification framework system such as Firefly Runtime, must first be registered with the notification framework. For example, the provider administrator sends an email request to the notification framework administrator and includes the name of the provider. In response, the notification framework administrator creates a service ID for the provider and registers the provider using the service ID and the provider name.

Once the provider is registered, the provider creates a notification model in order to send a notification to the notification framework. This notification model defines the data types that flow as part of the notification and is created based on the data types from the business model. The notification model is then registered with the notification framework. The notification provider may also create and register filter sets with the notification framework system. For example, the provider administrator may use a WebSphere Studio workbench to access and login to the notification framework using the service ID and password obtained when the provider was registered. The provider administrator may use the graphical user interface (GUI) provided by the notification framework plug-in to create filter sets. After the filter sets are created, the provider is able to send notifications to the notification framework system.

When a user subscribes to receive notifications, the user may only subscribe for notifications that originate from a notification provider to which the user has access. Thus, if a subscriber does not have access to a provider but would like to receive notifications from the provider, the user should make such a request to the provider. Consequently, the provider may add the subscriber to its access list. Once a subscriber is added to a provider's access list, the subscriber is eligible to receive notifications from that provider.

In addition, the subscriber defines the delivery channel preferences in order to receive notifications. For example, a subscriber may assign delivery channel preferences such as Simple Object Access Protocol (SOAP), Enterprise Java Bean (EJB), and Simple Mail Transfer Protocol (SMTP). A delivery channel may be associated with a subscription. When a notification matches a subscription, it is delivered to the owner of the subscription at the endpoint specified by the delivery channel associated with the subscription.

Furthermore, the subscriber may optionally define filters according to the user's needs. A subscriber may select filters created by the provider. A filter represents a condition that an incoming notification must satisfy in order for the notification to be delivered to the subscriber.

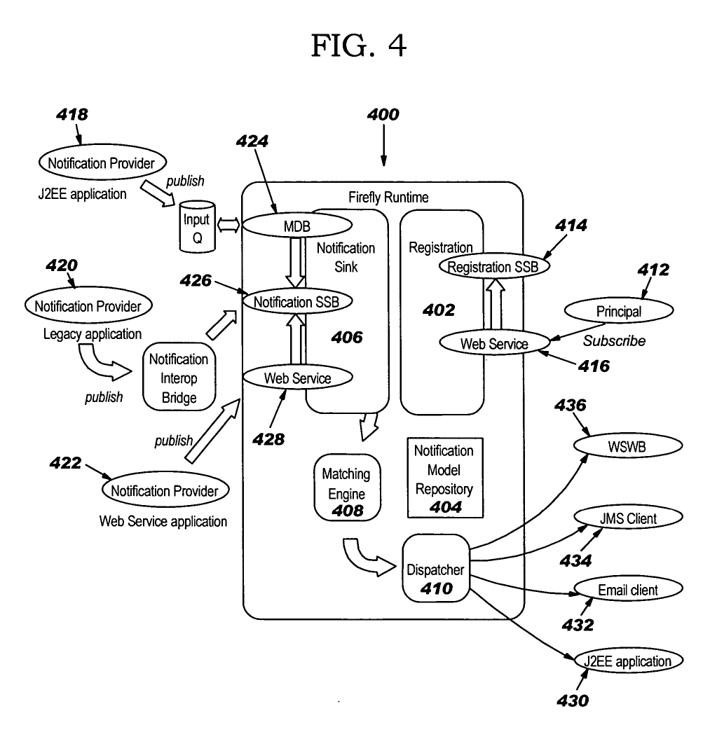

Turning now to FIG. 4, a block diagram of a Firefly Runtime notification framework that may be used to implement a preferred embodiment of the present invention is shown. Firefly Runtime notification framework may be implemented in a distributed data processing system, such as distributed data processing system 200 shown in FIG. 2. In the depicted example, Firefly Runtime framework 400 comprises core services including subscription registry 402, notification model repository 404, notification sink 406, matchmaking subsystem 408, and dispatching subsystem 410. Subscription registry 402 in Firefly Runtime framework 400 is used to accept and persist subscriptions from users and services, such as from principal 412. Subscriptions received from principal 412 are closely related to the provider notification models. Subscription registry 402 may be accessed using channels, such as EJB session bean invocation to registration session bean 414 and SOAP/Hypertext Transfer Protocol (HTTP) invocation 416.

Notification model repository 404 stores the business models which are registered by providers in a central repository. Although the implementation shown in FIG. 4 illustrates that notification model repository 404 resides in a relational database management system, notification model repository 404 may also reside in an XML file, XMI file, and the like. As models stored within Firefly Runtime framework 400 are considered current versions, providers must send updates to the model to notification model repository 404. Notification sink 406 receives notifications generated from notification providers, such as notification providers 418, 420, and 422, via channels such as JMS message 424, EJB session bean invocation to notification sink session bean 426, and SOAP/HTTP invocation 428.

Matchmaking subsystem 408 performs content based matching based on incoming notifications and the list of current subscriptions. For example, a relational database may be used to create dynamic SQL queries based on the provider's model as well as the incoming notification. When a match occurs, dispatching subsystem 410 is contacted with the original notification, a list of matched principals, and a list of dispatch channels. The notification may be dispatched using assigned delivery channels, such as EJB session bean invocation 430, SMTP message 432, JMS Message 434, and SOAP/HTTP Web service call 436.

Firefly Runtime framework 400 is presented as an example of an application framework for enterprise integration using a messaging based infrastructure in which the present invention may be embodied. Firefly Runtime framework 400 is not meant to imply architectural limitations to the present invention. Presently available message based infrastructures may include additional functions not shown or may omit functions shown in Firefly Runtime framework 400. A message based framework may be any infrastructure that is used to provide notifications on a distributed data processing system.

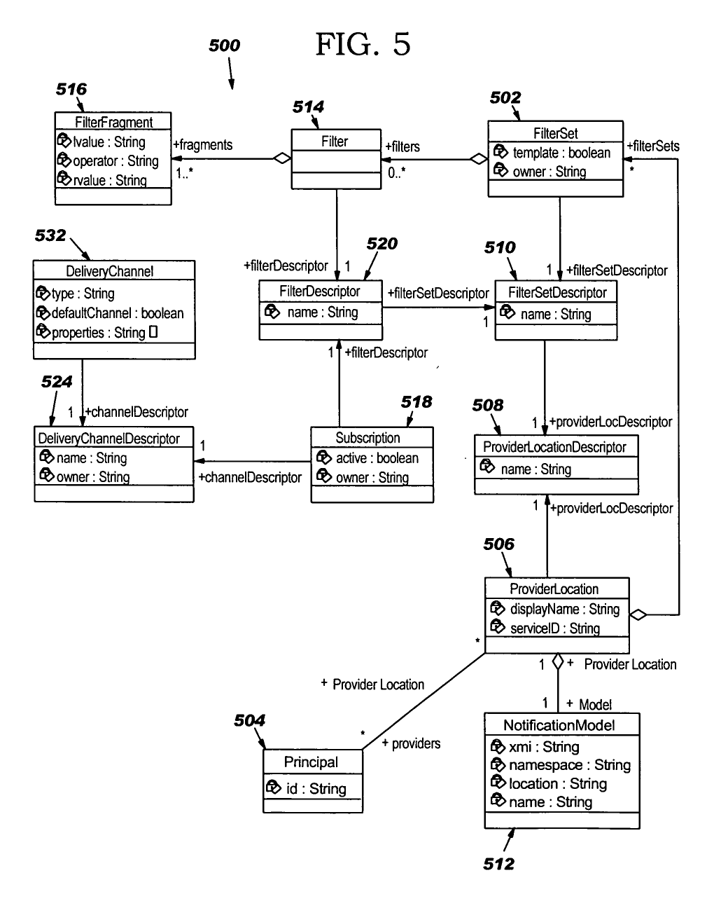

FIG. 5 is a class diagram illustrating an implementation of a notification framework, such as Firefly Runtime framework 400, in accordance with a preferred embodiment of the present invention. Notification framework subscription model 500 may be implemented in a data processing system, such as data processing system 300 shown in FIG. 3. This model is used as a means of capturing the data model that is used to convey information about subscriptions from the user interface to the server.

Notification framework subscription model 500 is shown to include filter set 502. Filter sets are defined by the providers, such as provider 504. The provider administrator may define filter sets using WebSphere Studio workbench to access and login to the notification framework using the service ID and password obtained when the provider was registered. The provider administrator may use the graphical user interface provided by the notification framework plug-in to create filter sets. Provider 504 is associated with filter set 502 through provider location 506, provider location descriptor 508, and filter set descriptor 510. Notification model 512, which contains the model a user may subscribe against, is associated with provider location 506.

Filter set 502 contains filters, such as filters 514, which in turn contain filter fragments, such as filter fragments 516. Subscription 518 is associated with filter 514 through filter descriptor 520. Subscription 518 is also associated with delivery channel 522 through delivery channel descriptor 524. Once filter sets 502 are created, provider 504 is able to send notifications to the notification framework system.

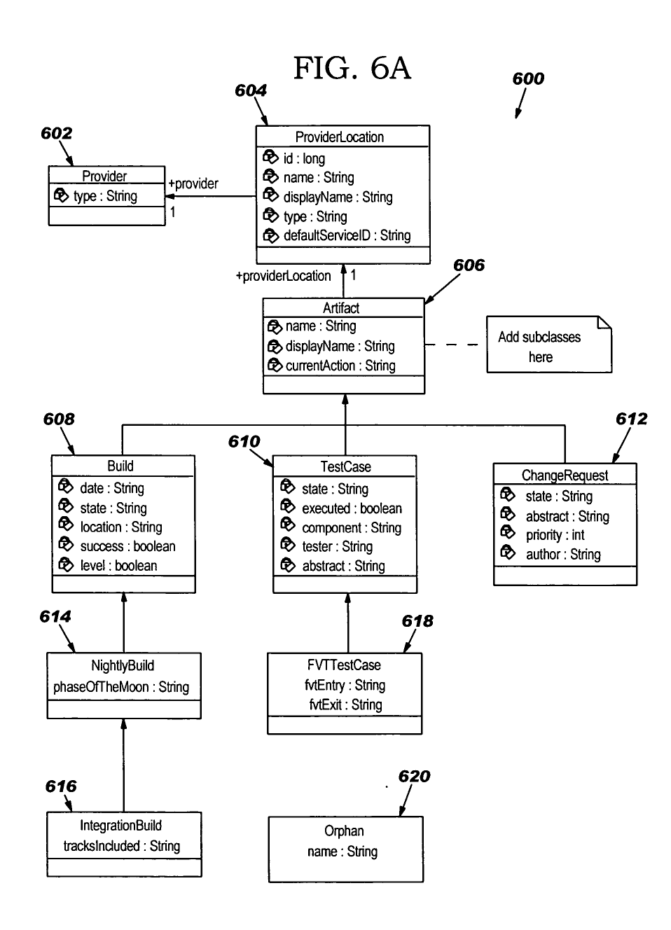

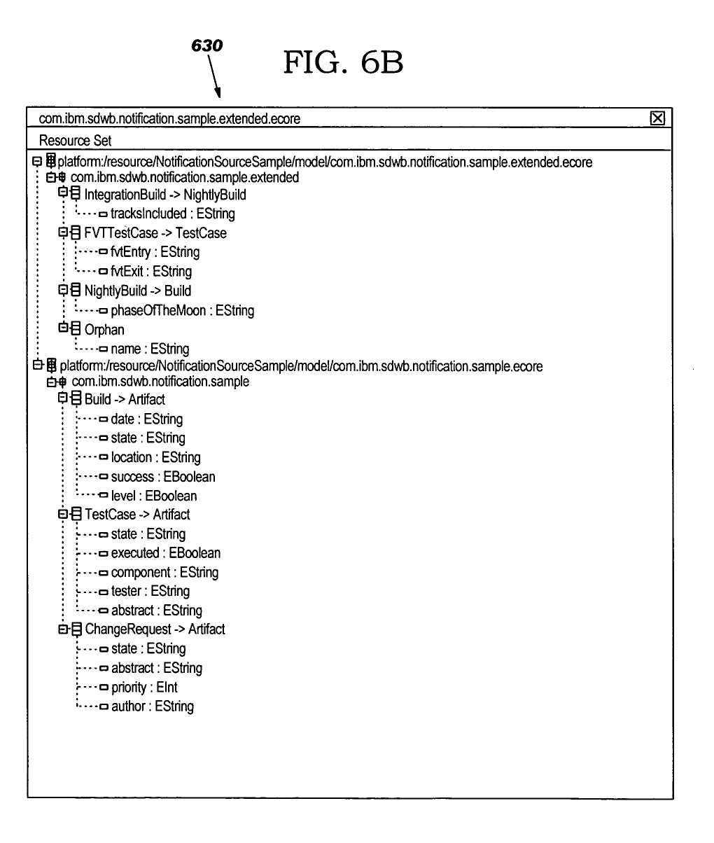

FIGS. 6-13 illustrate an example process using Eclipse Modeling Framework (EMF) to create a subscription based on a business model. EMF may be implemented in a notification framework, such as Firefly Runtime notification framework 400 in FIG. 4.

In this particular example, EMF is used to aid in the construction of a notification model within the notification framework. EMF is a basic Java development environment and code generation facility for building a development environment from plug-in components. EMF allows for developing models that may be defined using XML Metadata Interchange (XMI). XMI enables easy interchange of metadata among modeling tools and repositories in a distributed heterogeneous environment. For example, the notification model may be defined using a Unified Modeling Language (UML) modeling tool, such as Rational Rose. The notification model may also be defined using an XML schema or by annotating Java interfaces with model properties. Once the EMF business model is defined, the EMF code generator may be used to create a corresponding set of Java implementation classes. An internal metamodel called Ecore, which is a subset of Meta Object Facility (MOF), may use the EMF code generator to generate a complete Java Application Programming Interface (API) for the EMF notification model.

FIG. 6A is a class diagram illustrating an example notification model. Notification model 600 defines the data types that flow as part of notification. In this example, the notification model is created in EMF Encore format. Notification model 600 is shown to include provider 602 and provider location 604. Notification provider 602 specifies the providers, or applications, that are associated with the subscription and may be used to generate notifications to be sent to subscribers. As mentioned previously, prior to creating the notification model, the notification provider is first registered with EMF prior to sending notifications.

Once notification provider 602 is registered with the notification framework, notification provider 602 may create a notification model, such as notification model 600. Each provider has a provider location, such as provider location 604, which specifies the location of the provider. Notification model 600 may also contain artifacts, such as artifact 606, which represents process deliverables, such as use-cases, code, plans, test cases, and test results.

Provider 602 may be used to extend notification model 600, such that notification models Build 608, TestCase 610, and ChangeRequest 612 are created and form an inheritance relationship with artifact 606. In this manner, artifact 606 may be further defined by notification models Build 608, TestCase 610, and ChangeRequest 612.

In addition, notification model 600 may also be used to extend notification model 600. For example, NightlyBuild 614 may be created to inherit from Build 608, and be further defined by IntegrationBuild 616. Likewise, FVTTestCase 618 may be created to inherit from TestCase 610, and be further defined by Orphan 620.

FIG. 6B illustrates a sample set of subscriptions to the model described in notification model 600 displayed in a graphical user interface (GUI), such as graphical display 630. Graphical display 630 provides a tree view of the classes available in notification model 600 and their relationships to each other. Graphical display 630 is available to the user such that the user may view the notification model the user wants to subscribe against.

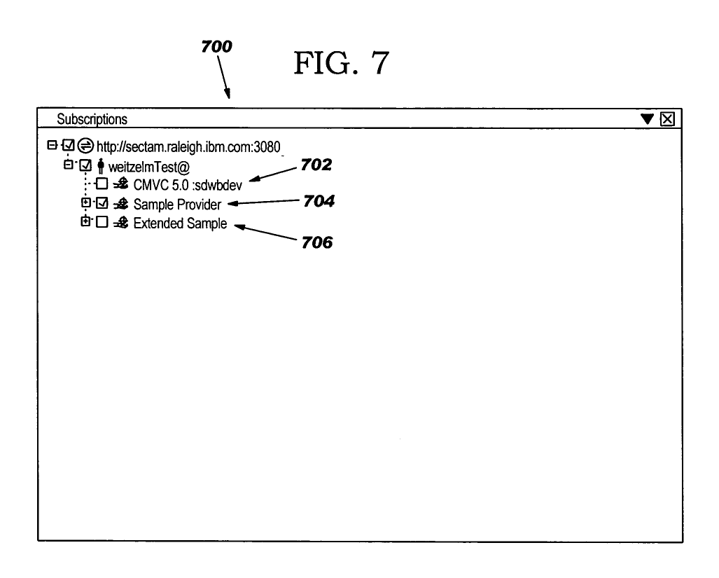

Turning now to FIG. 7, an example graphical user interface (GUI) 700 illustrating how a notification model may be registered with a notification broker (e.g., Firefly Runtime) in accordance with a preferred embodiment of the present invention is shown. Notification models “CMVC 5.0:sdwbdev” 702, “Sample Provider” 704, and “Extended Sample” 706 are registered with a notification broker by first serializing the notification models into XMI. For example, the objects are serialized and interchanged with XMI using a UML modeling tool, an XML schema, or by annotating Java interfaces with model properties. The provider administrator may send the generated Encore file to the notification framework administrator, who may then register the notification models on behalf of the provider.

Once the objects are serialized, notification models 702, 704, and 706 may be registered with a notification broker. As a result of registering the notification models with the notification broker, a subscriber may subsequently view the notification models the subscriber is authorized to subscribe against in GUI 700.

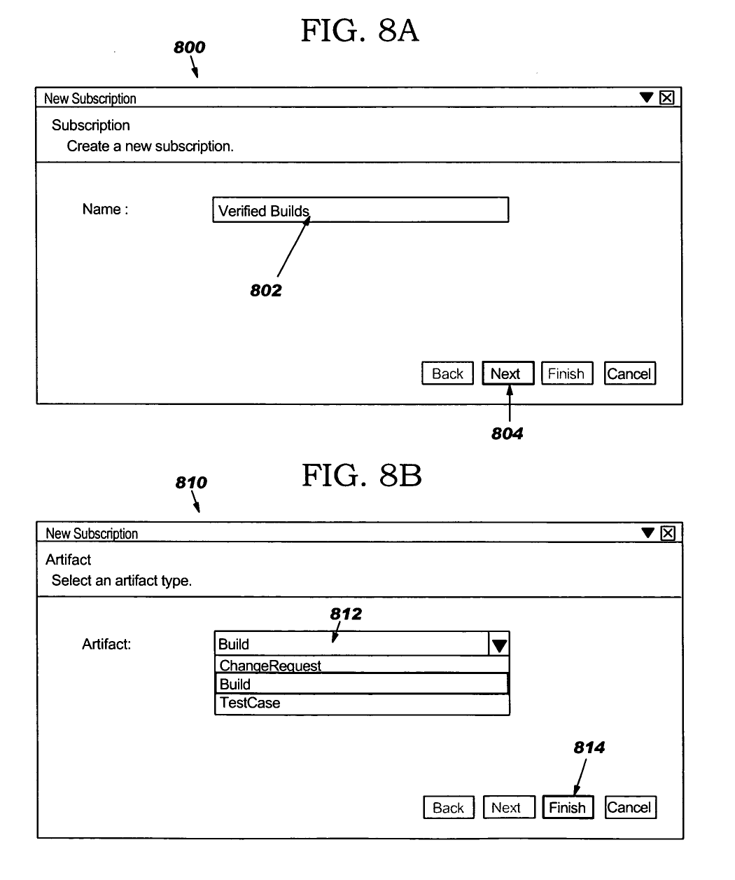

FIGS. 8A and 8B are example graphical user interfaces (GUIs) illustrating how a user may subscribe against a provider's notification models in accordance with a preferred embodiment of the present invention. In particular, FIG. 8A illustrates how a user may create a new subscription. When a user wants to receive a notification upon a certain event, a user may enter the name of the notification model in graphical user interface 800. The example in GUI 800 shows that a user may create a new subscription by entering a name for the subscription, such as “Verified Builds” 802. The user may then select next button 804 at the bottom of GUI 800 to continue the subscription process.

Once the subscription is named, the user may then select the subscription class, as shown in graphical user interface 810 in FIG. 8B. As EMF display 700 in FIG. 7 shows the user which notification models the user is authorized to subscribe against, the user may select an artifact type for the new subscription. In this example, the Build model is selected from dropdown list 812 from the list of classes available to the user for the subscription. The user may then select finish button 814 at the bottom of GUI 810 to continue the subscription process.

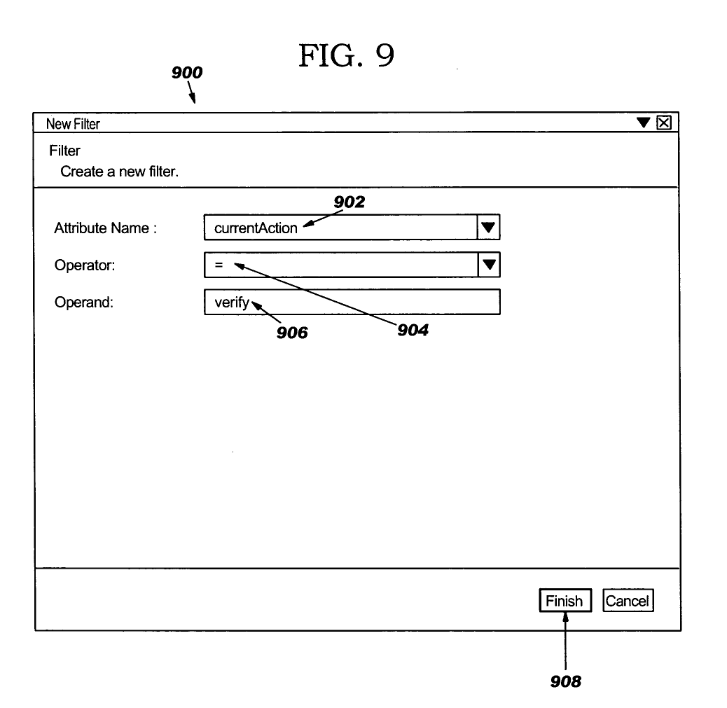

Turning now to FIG. 9, an example graphical user interface illustrating how filters may be added against attributes in accordance with a preferred embodiment of the present invention is shown. GUI 900 shows how a user may assign filters to a subscription once the user has created a subscription to a particular notification model.

The user may apply a filter against an attribute by first selecting an attribute name. In the example, attribute name “current action” has been selected from dropdown list 902. Once the attribute has been identified, the user may apply operators and values against the selected attribute. For example, for current action attribute, the “=” operator has been selected from dropdown list 904 and the “verify” operand has been entered in operand box 906. The user may then select finish button 908 at the bottom of GUI 900 to continue the subscription process.

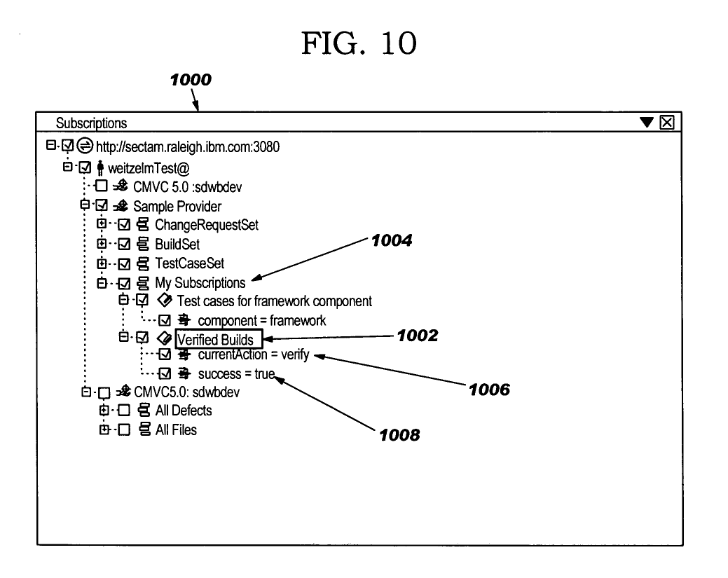

FIG. 10 is an example graphical user interface illustrating a subscriptions tree view in accordance with a preferred embodiment of the present invention. GUI 1000 illustrates an example of how the user may view the current subscription information against the notification model. In this example, selected “Verified Builds” subscription 1002 is located under “My Subscriptions” folder 1004. “Verified Builds” subscription 1002 contains “currentaction=verify” filter 1006 and “success=true” filter 1008. From GUI 1000, the user may easily discern that “verified builds” subscription 1002 is a subscription against Build model 608 in FIG. 6 for all builds that have passed verification.

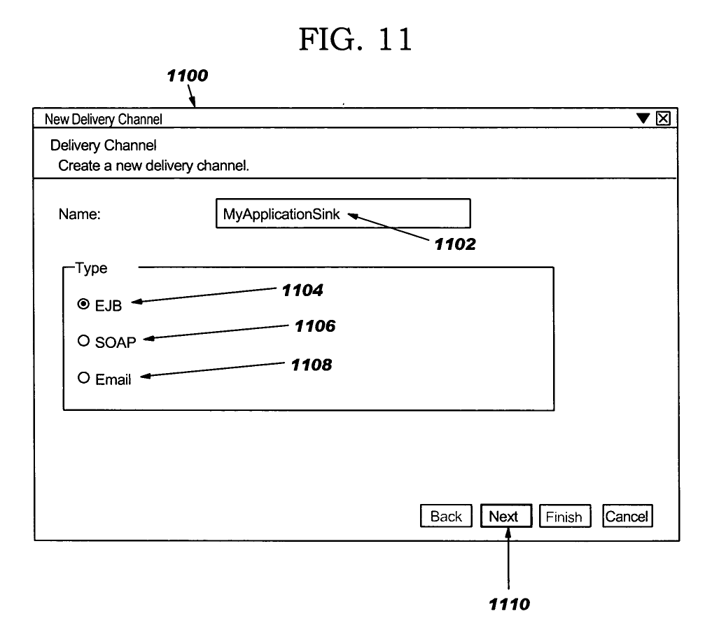

Turning now to FIG. 11, an example graphical user interface illustrating how delivery channels may be selected to dispatch notifications in accordance with a preferred embodiment of the present invention is shown. The subscriber must define the delivery channel preferences in order to receive notifications. A delivery channel describes a subscriber's message receiving characteristics and is a property of the subscription.

When a notification matches a subscription, it is delivered to the owner of the subscription at the endpoint specified by the delivery channel associated with the subscription. A subscriber can define one or more delivery channels.

The example in GUI 1100 shows a new delivery channel, “MyApplicationSink” 1102, has been created. Once the delivery channel is named, the user may then select the method of delivery. For example, GUI 1100 allows the user to select either EJB 1104, SOAP 1106, or Email (SMTP) 1108 delivery channel. Once the user has selected the delivery channel, the user may then click next button 1110 at the bottom of GUI 1100 to continue the subscription process.

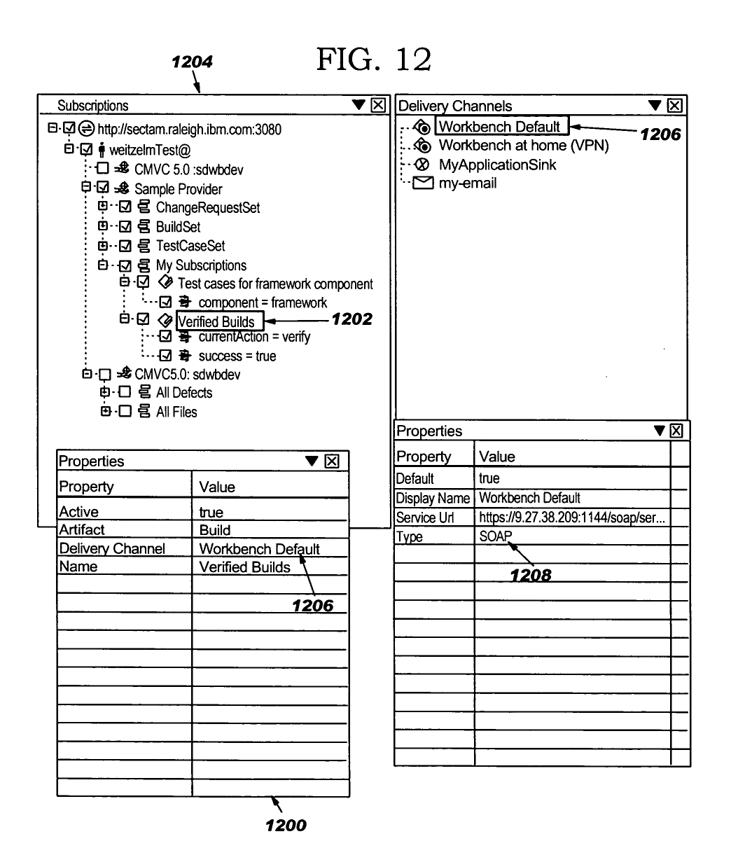

FIG. 12 are example graphical user interfaces illustrating notifications delivered via Web services in accordance with a preferred embodiment of the present invention. FIG. 12 illustrates how the delivery channel is a property of the subscription. For example, properties GUI 1200 contains the properties for “verified builds” subscription 1202. Properties display 1200 may be shown by selecting a particular subscription in subscriptions GUI 1204.

When a notification is to be delivered, the delivery channel property for the subscription is accessed. In this example, delivery channel property 1206 has a value of “workbench default”. Consequently, workbench default delivery channel 1206, in this case SOAP 1208, is used to send the notification to the subscriber.

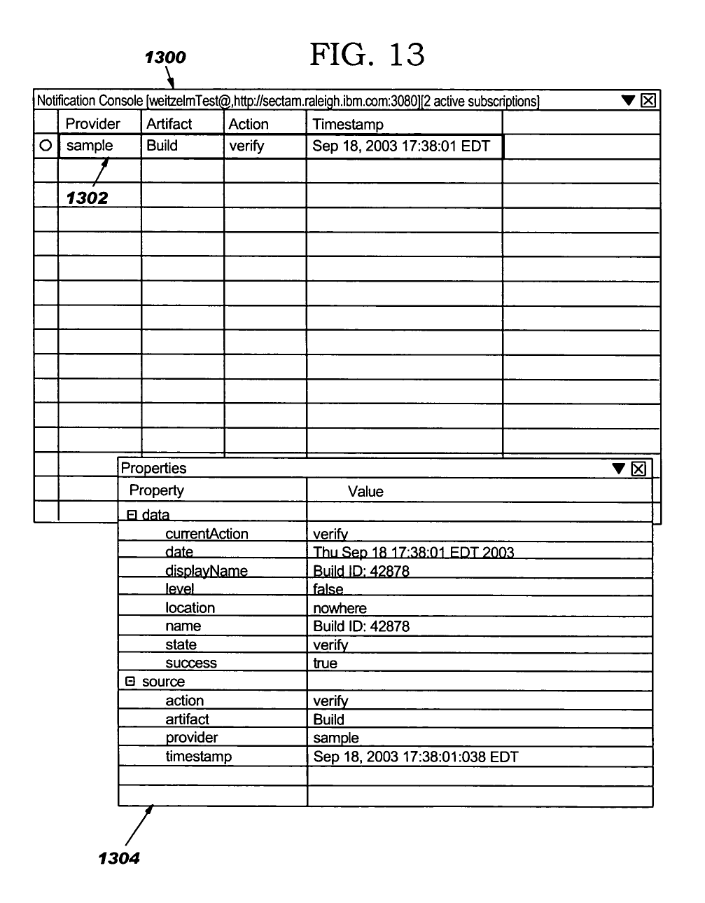

Turning now to FIG. 13, an example graphical user interface illustrating how notifications may be received in accordance with a preferred embodiment of the present invention. In this example, the Eclipse workbench is shown receiving a notification containing the models in notification console 1300. Notification console 1300 is shown to have received notification 1302 for Build model 608 for all builds that have passed verification. Properties display 1304 may be shown by selecting notification 1302. Properties display 1304 may provide additional detail regarding the notification that is not shown in the notification console.

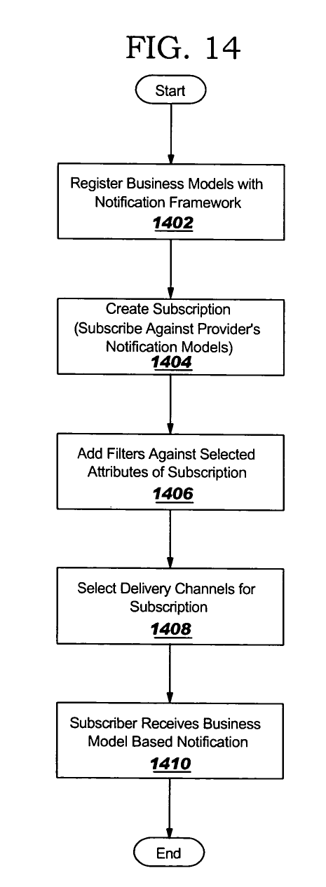

FIG. 14 is a flowchart of a process for using business models for subscriptions in accordance with a preferred embodiment of the present invention. The process illustrated in FIG. 14 may be implemented in a distributed data processing system, such as data processing system 200 in FIG. 2.

The process begins by registering business models with a notification framework (step 1402). Next, the user creates a new subscription to subscribe against a provider's notification models (step 1404). In this step, the user names the subscription and selects the class for the subscription. Filters may then be added against the selected attributes of the subscription (step 1406). For example, the notification model is first introspected to determine the attributes. Once the attributes are determined, filters in the form of operators and values are applied against each attribute.

Next, notification delivery protocols are selected for the subscription (step 1408). For example, a user may select that the notification be delivered via a delivery channel such as EJB, SOAP, or Email (SMTP). The subscriber may then receive the notification based on the business model (step 1410), with the process terminating thereafter.

Thus, the present invention provides a method, apparatus, and computer instructions for allowing business models to be used directly in message oriented middleware, and specifically in publish/subscribe brokers. The advantages of the present invention should be apparent in view of the detailed description provided above. Messaging systems using topics with message selectors may provide notifications to applications. However, such topic-based approaches have proven to be problematic since it is often difficult to transform the business model into an effective topic, as well as potentially resulting in a large number of topics. In addition, it may be difficult to express all attributes in a message header when the model contains multiple levels. In contrast, the present invention uses the model from the business domain as the basis for notification subscriptions to allow for defining filters directly against the model's attributes, reducing problems caused by translating business models to a middleware description.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for using business domain language to express subscriptions in publish/subscribe based message oriented middleware, comprising:
registering a business model with a service provider;
creating a subscription, wherein the subscription is expressed using the business model;
publishing a notification based on the subscription, wherein the notification is an instance of the business model used to create the subscription.

2. The method of claim 1, further comprising:
adding filters against selected attributes of the subscription;
associating at least one delivery channel with the subscription;
delivering the notification based on the associated delivery channel.

3. The method of claim 2, further comprising:
receiving the notification at a subscriber, wherein information in the notification is the same information against which the subscriber subscribed.

4. The method of claim 1, wherein the service provider is a notification framework.

5. The method of claim 4, wherein the notification framework is Firefly Runtime Framework.

6. The method of claim 1, wherein Eclipse Modeling Framework (EMF) is used to express the business model.

7. The method of claim 2, wherein association of the at least one delivery channel to the subscription may be performed using Web Services Invocation Framework (WSIF).

8. The method of claim 2, wherein the at least one delivery channel is one of a Simple Object Access Protocol (SOAP), Enterprise Java Bean (EJB), or Simple Mail Transfer Protocol (SMTP).

9. A data processing system for using business domain language to express subscriptions in publish/subscribe based message oriented middleware, comprising:
registering means for registering a business model with a service provider;
creating means for creating a subscription, wherein the subscription is expressed using the business model;
publishing means for publishing a notification based on the subscription, wherein the notification is an instance of the business model used to create the subscription.

10. The data processing system of claim 9, further comprising:
adding means for adding filters against selected attributes of the subscription;
associating means for associating at least one delivery channel with the subscription;
delivering means for delivering the notification based on the associated delivery channel.

11. The data processing system of claim 10, further comprising:
receiving means for receiving the notification at a subscriber, wherein information in the notification is the same information against which the subscriber subscribed.

12. The data processing system of claim 9, wherein the service provider is a notification framework.

13. The data processing system of claim 12, wherein the notification framework is Firefly Runtime Framework.

14. The data processing system of claim 9, wherein Eclipse Modeling Framework (EMF) is used to express the business model.

15. The data processing system of claim 10, wherein association of the at least one delivery channel to the subscription may be performed using Web Services Invocation Framework (WSIF).

16. The data processing system of claim 10, wherein the at least one delivery channel is one of a Simple Object Access Protocol (SOAP), Enterprise Java Bean (EJB), or Simple Mail Transfer Protocol (SMTP).

17. A computer program product for using business domain language to express subscriptions in publish/subscribe based message oriented middleware, comprising:
first instructions for registering a business model with a service provider;
second instructions for creating a subscription, wherein the subscription is expressed using the business model;
third instructions for publishing a notification based on the subscription, wherein the notification is an instance of the business model used to create the subscription.

18. The computer program product of claim 17, further comprising:
fourth instructions for adding filters against selected attributes of the subscription;
fifth instructions for associating at least one delivery channel with the subscription;
sixth instructions for delivering the notification based on the associated delivery channel.

19. The computer program product of claim 18, further comprising:
seventh instructions for receiving the notification at a subscriber, wherein information in the notification is the same information against which the subscriber subscribed.

20. The computer program product of claim 17, wherein the service provider is a notification framework.

21. The computer program product of claim 20, wherein the notification framework is Firefly Runtime Framework.

22. The computer program product of claim 17, wherein Eclipse Modeling Framework (EMF) is used to express the business model.

23. The computer program product of claim 18, wherein association of the at least one delivery channel to the subscription may be performed using Web Services Invocation Framework (WSIF).

24. The computer program product of claim 18, wherein the at least one delivery channel is one of a Simple Object Access Protocol (SOAP), Enterprise Java Bean (EJB), or Simple Mail Transfer Protocol (SMTP).
